(19) United States
(12) Patent Application Publication
(10) Pub. No.: US 2006/0059136 A1
(43) Pub. Date: Mar. 16, 2006

(54) Domain bar

(75) Inventors: Michael A. Wooldridge, Pleasant Hill, CA (US); Gary Z. Khachadoorian, Clayton, CA (US); Peter Feinberg, McLean, VA (US); David Morse, Oak Hill, VA (US); Jeff Grosman, Washington, DC (US)

Correspondence Address: KENYON & KENYON LLP, ONE BROADWAY, NEW YORK, NY, 10004, US

(73) Assignee: NETWORK SOLUTIONS, LLC

(21) Appl. No.: 11/224,083

(22) Filed: Sep. 13, 2005

Related U.S. Application Data
(60) Provisional application No. 60/609,003, filed on Sep. 13, 2004.
(60) Provisional application No. 60/622,841, filed on Oct. 29, 2004.

(51) Int. Cl. G06F 17/30; G06F 15/16

(52) U.S. Cl. 707/3; 709/202

(57) ABSTRACT

A toolbar for WHOIS searching and interacting with a domain name registrar. The toolbar may include buttons, form fields and drop down menus, and performs WHOIS searches, WHOIS wildcard searches, provides domain registration services. Queries include WHOIS domain searches by domain, by IP address, and by Network Information Center (NIC) Handle searches. Domain registrations can be created, transferred and renewed.

### RELATED APPLICATIONS

Priority is claimed from U.S. Provisional Applications 60/609,003 filed Sep. 13, 2004 and 60/622,841 filed Oct. 29, 2004, which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

WHOIS is a protocol for submitting a query to a database for determining, among other things, the owner of a domain name, an Internet Protocol (IP) network, or an autonomous system number. Several public websites in the market let users do domain name searches or WHOIS searches. However, in order to use these services, a user must navigate to the website. For users who regularly perform such searches, working in areas such as network management, web hosting and design, and trademark practice, the additional navigation and windows needed to initiate a search are obtrusive.

Accordingly, there is a need for an unobtrusive search utility that is always available when a web browser is open.

### SUMMARY OF THE INVENTION

A toolbar is disclosed for WHOIS searching and interaction with domain name registrars. The bar may include buttons, form fields and drop down menus, such as an entry field with a search history drop down, a new domain search button (action), a WHOIS search button (action), a wildcard search button (action), an options button or menu (configuration menu), an alerts button or menu (action), and additional access to additional features such as a pop-up blocker enable/disable button (report and action) and a help drop down menu.

Queries include WHOIS domain searches by domain, by IP address, or by Network Information Center (NIC) Handle and WHOIS wildcard searches. Provision is also made to send alerts to the toolbar.

### BRIEF DESCRIPTION OF THE DRAWINGS

FIG. 1 is a flow chart illustrating operation of a toolbar according to first and second embodiments of the invention.

FIG. 2 is a block diagram illustrating operation of a toolbar according to the first and second embodiments of the invention.

FIG. 3 is a first exemplary result of a WHOIS search.

FIG. 4 is a flow chart illustrating how the subject matter of the WHOIS search can be recognized.

FIG. 5 is a second exemplary result of a wildcard WHOIS search.

FIG. 6 is an example of a toolbar in accordance with the first and second embodiments.

FIG. 7 is a flow chart illustrating a WHOIS search operation in conjunction with a pop-up menu.

FIG. 8 is an exemplary pop-up menu used with the operation of FIG. 7.

FIG. 9 is an exemplary result of a domain name search.

FIG. 10 is an exemplary options dialogue box for customizing behavior of the toolbar.

FIG. 11 illustrates a search history feature.

FIG. 12 is an exemplary display of an alert by the toolbar.

FIG. 13 illustrates components of an exemplary computer system upon which the toolbar may reside.

### DETAILED DESCRIPTION

A first embodiment of the invention is a toolbar plug-in to a browser program providing access to WHOIS searching. A second embodiment of the invention is a toolbar plug-in to a browser program providing access to a domain name registrar.

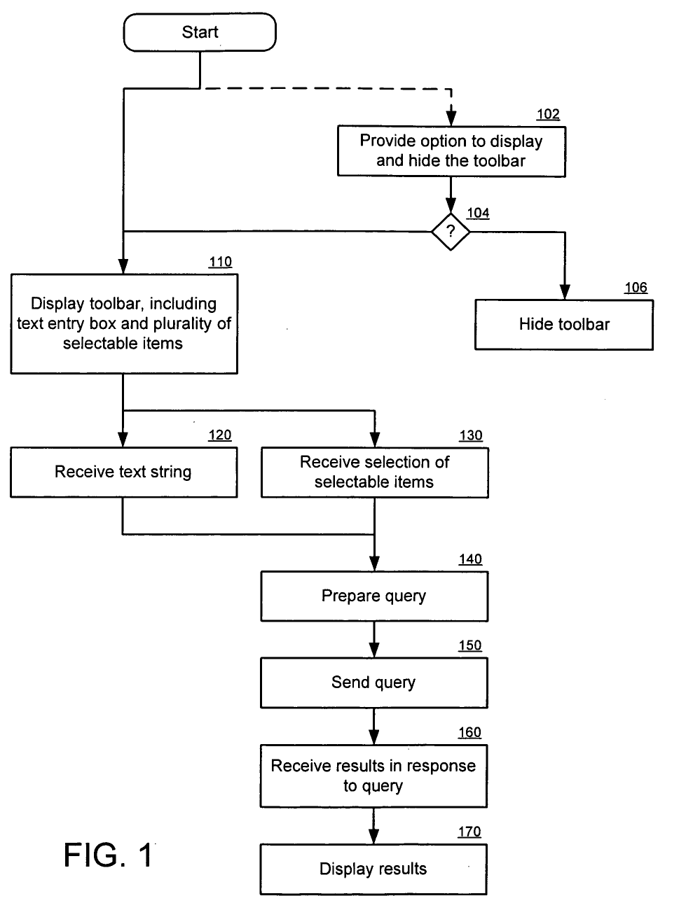

FIG. 1 is a flowchart illustrating operation of the toolbar in accordance with the first and second embodiments of the invention.

The toolbar may provide an option to display or hide the toolbar (102). If an instruction is received to hide the toolbar (104), the toolbar bar is hidden (106). Otherwise, the toolbar is displayed (110) in the browser window. If the toolbar is displayed, at least a portion of the toolbar is persistently displayed, independent of changes in content displayed by the web browser program.

The toolbar includes a text entry box and a plurality selectable items. The text entry box is a receptacle for the information to be searched. The plurality of selectable items define, among other things, types of searches which can be performed and particular interactions with a domain name registrar. Exemplary selectable items may be in the form of buttons, a pull-down menu, or some combination thereof.

After a text string is received in the text box (120), and a selection is received of a selectable item (130), an agent prepares (140) a search query based upon the text string and the selected selectable item. In a client-server model, an agent is the part of the system that performs information preparation and exchange on behalf of a client or server.

The query is then sent over a network (150), a response to the query is received (160), and the response is displayed (170) on the computer having the toolbar.

In the first embodiment, the selectable items comprise searches for a WHOIS database, and the query sent (150) is for a WHOIS database. In the second embodiment, the selectable items comprise interactions with a domain name registrar, and the query sent (150) is for a domain name registrar. In both embodiments, the query may be sent either directly to its destination, or may be sent to a proxy or intervening service. Also, while the agent is preferably embedded within the toolbar plug-in application program, the agent may reside elsewhere, such as with the proxy or intervening service. In any case, the query sent by the toolbar is based upon the received text string and the selected item.

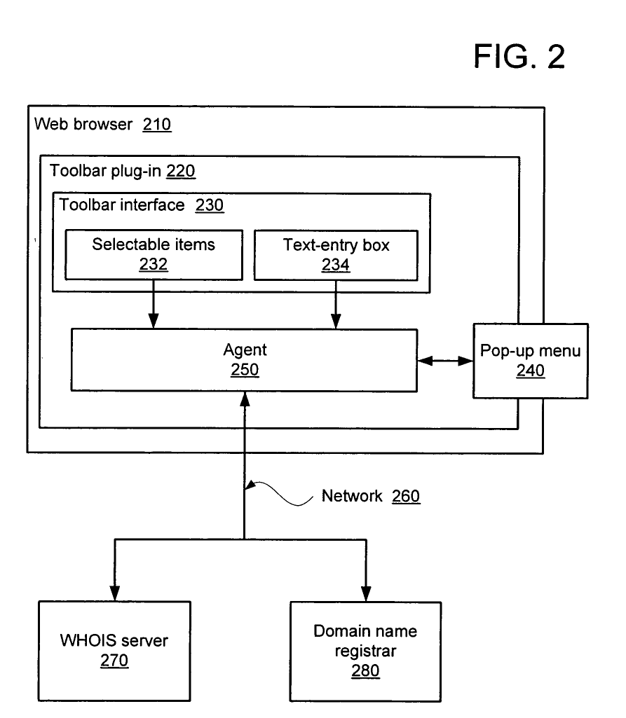

FIG. 2 is an exemplary block diagram illustrating operation of the toolbar according to the first and second embodiments of the invention. The toolbar (220) is a plug-in to a web browser (210), and includes a toolbar interface (230) and the agent (250). The toolbar interface (230) displays the selectable items (232) and the text-entry box (234). The agent (250) send the queries for the WHOIS server (270) and the domain name registrar (280) over a network (260), and the results of the queries are displayed. The agent may also receive a selection of selectable items from a pop-up menu (240) as an additional feature discussed below.

As an exemplary operation, if the user enters a variable in the entry field (234), and clicks a selectable item for “Domain Search”, the toolbar will execute a new domain search of the specified value. The user may specify the top-level domain (TLD) to be searched in the entry field (234), for example, “nsi.com”. If the user does not specify a TLD, the toolbar may append on a TLD such as “.com” before executing the search command, or treat the search as a wildcard search.

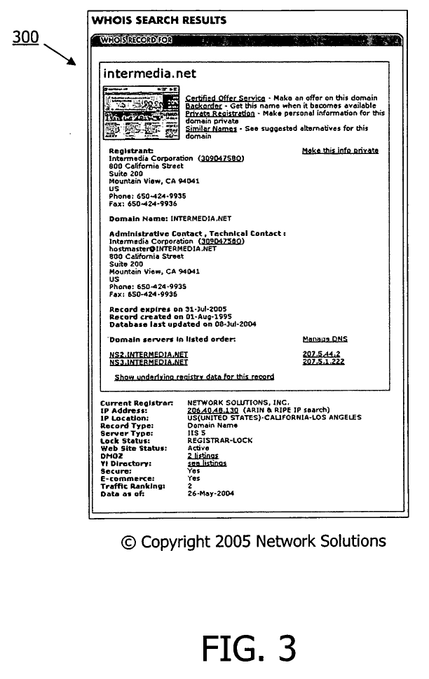

FIG. 3 is an example of WHOIS search results (300) which may be received and output in response to the query of the first embodiment. The search results (300) may be displayed through the web browser program (210), in an existing window or in a new tab or window.

In accordance with the first embodiment, the types of searches and selectable items displayed may include a domain name WHOIS search, an IP address WHOIS search, a WHOIS search based upon a Network Information Center (NIC) handle, and a wildcard search.

The wildcard search may be a WHOIS search of at least all current domains, and may further include deleted domains. The wildcard search may be a literal wildcard search and may look for all active, deleted and formerly registered domains that contain that literal phrase (either preceded by other characters, and/or before other characters).

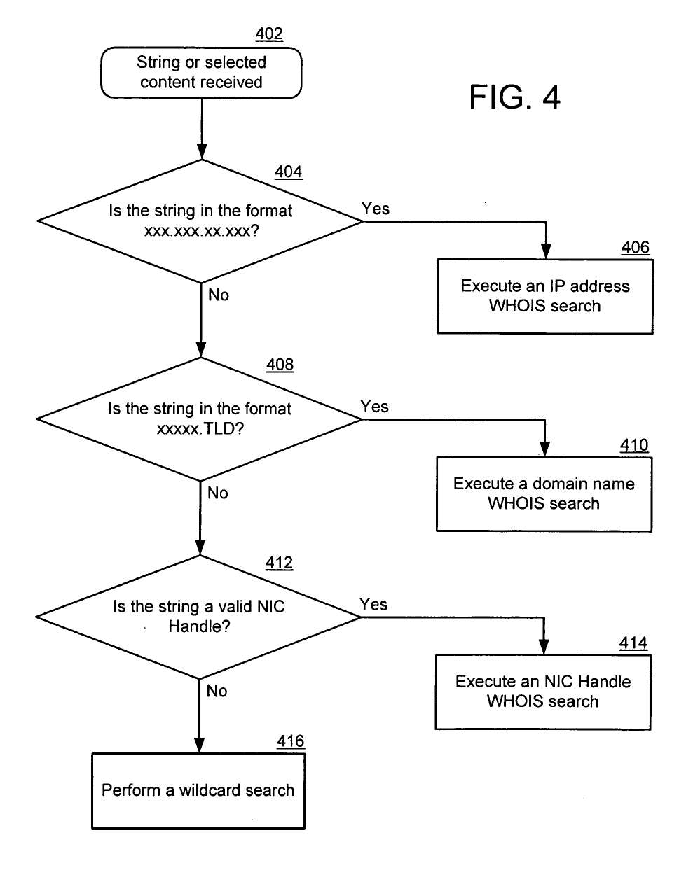

Additionally, the different search types may be a static list of options, presented without regard to the search string received, or may be dynamically adjusted based on the search string. As shown in FIG. 4, when a search string (402) is received, it may be parsed to determine the appropriate search. For example, if the string is in an IP address format (404), an IP address WHOIS search is executed (406); if the string is in the format of a domain name (408), a domain name WHOIS search is executed (410); if the string appears to be a valid NIC handle (412), a NIC handle WHOIS search is executed (414); and if none of the other formats apply, a WHOIS wildcard search may be performed (416). Accordingly, if a menu is used to present the selectable items, the items enabled in the menu may be defined as those types of searches that are possible for the entered string. Likewise, refutation can be used to eliminate or deselect items in the menu that do not correspond to the format of the entered string.

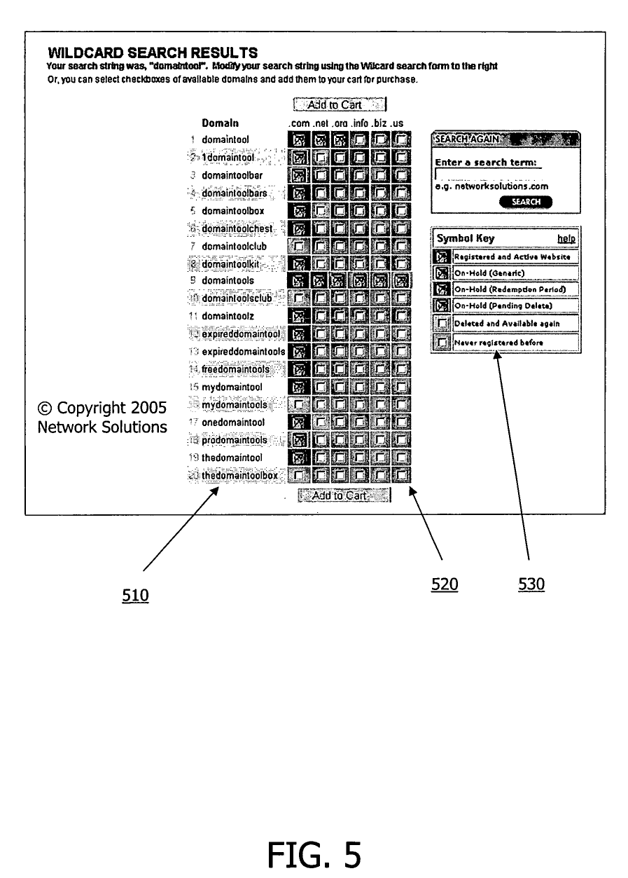

FIG. 5 illustrates exemplary results of a WHOIS wildcard search in which an independent status (520) is provided for each domain (510). For example, a search may be run against a plurality of extensions (e.g., com, net, org, biz, info, tv, us, cc, ws, bz, vg, gs, tc, ms) which are displayed in the results with an indication as to whether each are available.

A symbol key (530) identifies different types of status available, such as “registered and active website,” “on-hold (generic),” “on-hold (redemption period),” “on-hold (pending deletion),” “deleted and available again,” and “never registered before.” When “registered and active,” “On-Hold (Generic),” “On-Hold (Redemption Period),” or “On-Hold (Pending Delete)” is selected (i.e., clicked), a WHOIS search argument may be sent (e.g., 150), as described above, and a WHOIS Search Results Page is received and displayed (e.g., 160, 170). Any available domain may be represented with a checkbox that, if checked when the “Add to Cart” button is clicked, will send a multi-argument string to a domain name registrar as a new domain search query.

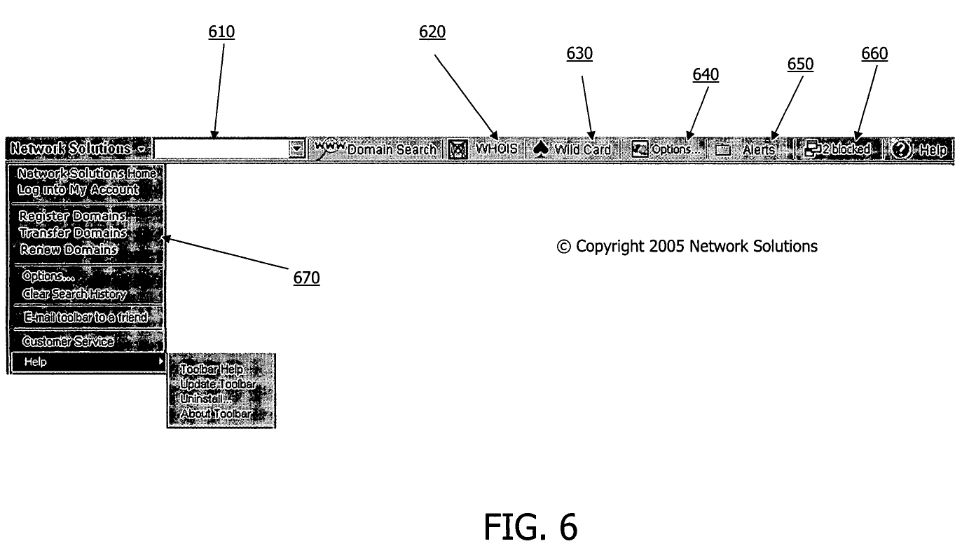

FIG. 6 is an example of a toolbar in accordance with the first and second embodiments of the invention. Text is input via the text entry box (610). Selectable items are illustrated as both a pull-down/drop-down menu (670) and buttons (620, 630). As an example that may be used with the second embodiment, the pull-down menu (670) includes a list of interactions with a domain name registrar. The buttons (620, 630), initiate a WHOIS search, as might be used with the first embodiment. Either form of selectable items (menus, buttons) may be used with either embodiment. In addition, the example toolbar includes other features which may be included, such as a selection for user-configurable options (640), a link to, or menu of, alerts (650) that may be received through the toolbar, and a pop-up blocker feature (660) that reports the number of windows blocked.

Examples of features that may be included in the drop-down menu (670), as illustrated in FIG. 6, include a link to the toolbar provider's homepage (e.g., a registration service provider); a link to log in to an affiliated account;, options to register, transfer, and renew domains; access to toolbar options; the ability to clear a search history; an option to e-mail the toolbar to a friend; a link to toolbar customer service; and a link to help or a help sub-menu drop down. The menu selection for “E-mail Toolbar to a Friend” may invoke a user's default client e-mail application (e.g., Microsoft Outlook) with a pre-formatted HTML message included with the toolbar by the toolbar provider. The menu selection for “Customer Service” may invoke a URL.

A help sub-menu may include a variety of options. A first sub-menu option may be “Toolbar Help,” which will take the user to a general toolbar help website at a specific URL. A second sub-menu option may be “Update Toolbar,” which will pull new code from a remote distribution application. The toolbar may communicate with the distribution application to identify it's unique “AffiliateID” (i.e., a unique identifier assigned to the toolbar), then compare the current toolbar version to the latest version. If the user has an out-of-date version, the distribution application may re-load the AffiliateID into a new toolbar and send the customer an executable with the new toolbar version inside. If the user has the current version, the distribution application may serve a dialogue box that says, “You have the most recent version of the toolbar already”.

A third sub-menu option may be “Uninstall . . . ”, which will serve the user a dialogue box such as, “If you click UNINSTALL below, this toolbar will be completely removed from your machine” with the option to “CANCEL” or “CONTINUE”. If the user clicks “UNINSTALL”, the application can remove all toolbar code and objects completely from the user's desktop machine without a trace. A fourth sub-menu option may be “About Toolbar”, which serves a page that tells the user basic “about” information.

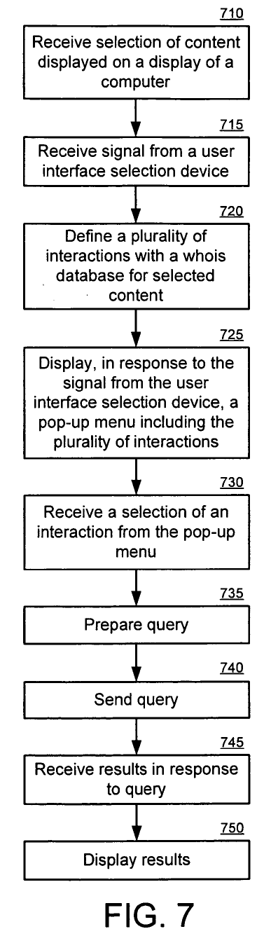

As an additional feature of the first embodiment, searches may be initiated using text or an object displayed by the computer and selected by a user. As shown in FIG. 7, a selection of content displayed on the computer is received (710). This content may include, among other things, text or a graphic object including embedded information. After a signal is received from a user interface selection device (e.g., mouse or other pointing device, or keyboard), a plurality of interactions with a WHOIS database are defined for the selected content (720). This plurality of interactions may be a static list, or may be tailored to content of the selected text or object, as discussed above with regard to FIG. 4. The signal may be, for example, a “click” from a particular mouse key or a predetermined keystroke.

Thereafter, the plurality of interactions is displayed in an interactive pop-up menu (725). After a selection is received from the pop-up menu (730), using the same techniques as discussed above, a WHOIS query is prepared (735) and sent (740), and after a response is received (745), the results are displayed (750).

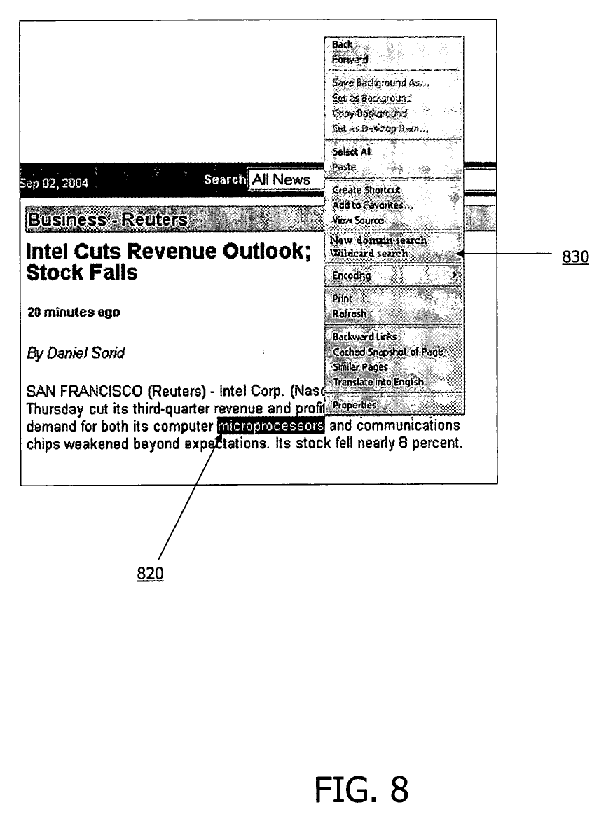

FIG. 8 illustrates an example of how the interface to the features of FIG. 7 might appear. In particular, FIG. 8 shows a selection of text (820) and a pop-up menu (830) containing a plurality of selectable items corresponding to predefined interactions with a WHOIS database. In this example, the user has highlighted the word “microprocessors” (820) in the page body, and clicked the right-hand mouse button to get the displayed menu (830).

In the pop-up menu (830), the toolbar has populated additional options underneath the “View Source” entry, (1) “New domain search” and (2) “Wildcard search,” that will act just as though the user clicked either the “Domain Search” or the “Wildcard Search” button, respectively. “New domain search” may initiate a search in accordance with the techniques discussed above with regard to FIG. 4.

The selected text or object may appear in the web-browser or in an address bar of the web browser. However, depending upon the support offered by the operating system of the computer, it is also possible to receive selected text and objects from other applications. Additionally, the pop-up menu (830) WHOIS search feature of the toolbar plug-in may be utilized, even when the toolbar itself is hidden. Further, although the above implementation of the pop-up menu WHOIS search is as a part of the toolbar, another embodiment of the invention is to implement the pop-up menu WHOIS search as a stand-alone application or plug-in, retaining the agent (250) but omitting the toolbar interface (220).

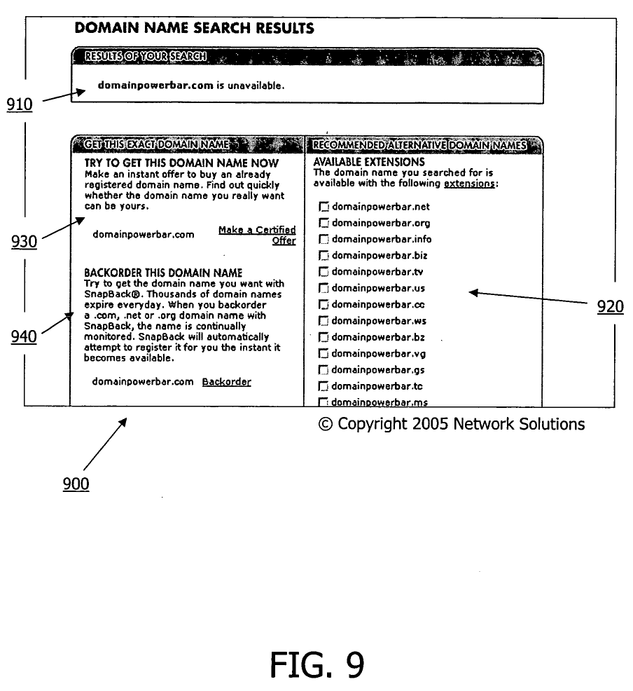

FIG. 9 is an exemplary result (900) displayed in response to a request to a domain name registrar in accordance with the second embodiment. In this example, a domain registration was attempted from the toolbar, but the domain name is unavailable (910). This response includes a list of alternative domains that might be registered (920), an option to use a broker service to buy the domain from the existing owner (930), and the option of placing a backorder on the domain name, should it become available (940). The search results (900) may be displayed through the web browser program (210).

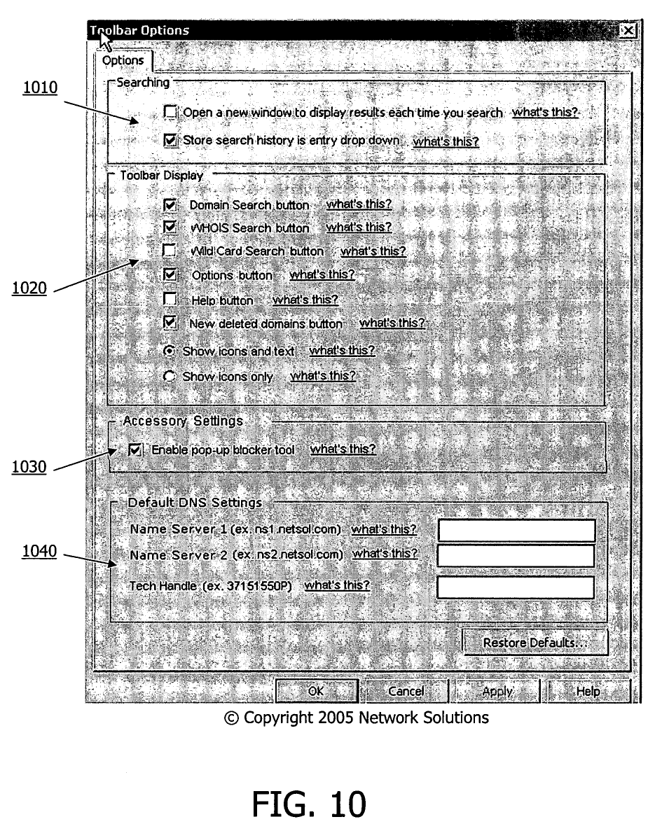

FIG. 10 is an exemplary options dialogue box accessed via the “options” button (640) of the toolbar. Examples of options that may be provided include customizing search and toolbar behavior (1010), customizing what features appear on the toolbar (1020), what accessories are enabled (1030), and any network-specific information (1040) which may be provided to the toolbar. As illustrated, the search and toolbar behavior (1010) include select-box options to open a new window to display results each time a search is executed, or if the search results will come up in the current browser window; and whether to store a search history and display the history in an entry box drop down. Customization (1020) includes selecting which buttons will appear on the toolbar, and whether the toolbar buttons are icons or icons and text. If a user de-selects all of the buttons which may be displayed in the toolbar, but the user enters a search string in the text entry field (e.g., 610) and clicks ENTER, the toolbar will perform a default search, which can be set to be a new domain search. Moreover, even if the buttons are off, “WHOIS search,” “wildcard search,” and the like may still appear in the drop-down menu (e.g., 670, 830).

An exemplary accessory which can be enabled or disabled (1030) is a pop-up window blocker. The toolbar may keep a tally of the number of pop-ups blocked, and, may allow the user to turn off the pop-up blocker for a specific 2nd level domain. The user may select to disable or re-enable the pop-up blocker for any 2nd level domain.

Exemplary network-specific information (1040) are default Domain Name Servers (DNS) to be applied to every new or transferred domain name registered through the toolbar. The DNS settings may include entry fields which may populate the <hostname1>, <hostname2>and <techhandle>fields in the affiliate code embedded in toolbar hyperlinks. The toolbar may do field level validations on the DNS and Tech Handle fields to ensure that (1) all data entered is valid and (2) that all three fields are populated. If the validation routine fails the toolbar may display an error/warning message to the user in a dialogue box.

Exemplary validation routines are as follows:
Hostname 1 and Hostname 2 are formatted as name servers;
Hostname 1 and Hostname 2 are active, valid name servers (ping the name servers);
Tech handle is a valid NIC Handle.

If user does not specify a Hostname 1, Hostname 2 and Tech Handle, then, the toolbar may update all affiliate coded links so as to not utilize these variables. All subsequent hyperlinks in the WHOIS Search Results and Wildcard Search Results pages may continue this rule, so that if a user does not specify these variables in the options area, the coded links may be modified to not include these variables.

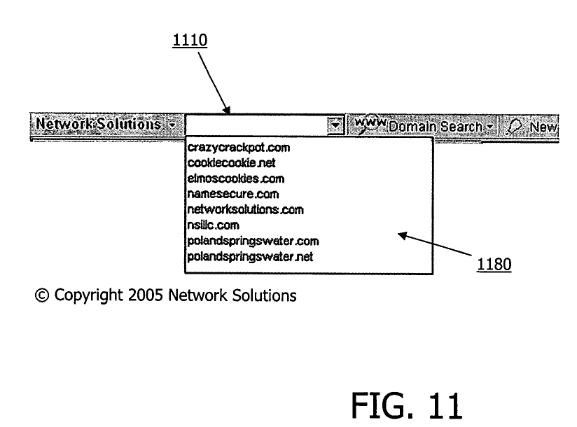

FIG. 11 illustrates a search history (1180) that may be included with the toolbar text entry box (1110). The user may be provided an option to clear the history, and searches are saved in the drop down menu only if a user has selected the option to store their search history. If searches are saved, and if the number saved reaches a preset maximum, the oldest search may be replaced by a new search in the search history. The search history can remain indefinitely so long as the user does not clear his/her history, or turn off the store search history feature in the Options dialogue box.

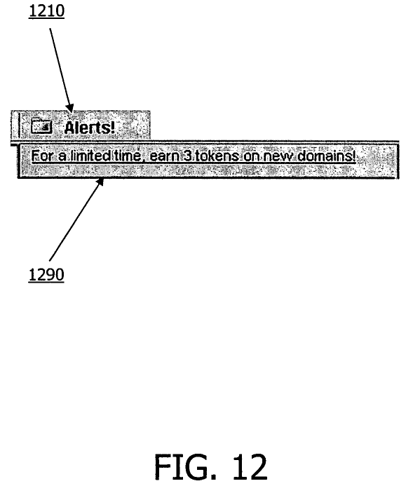

FIG. 12 is an example of the alert menu (1250) displaying an alert (1290) received by the toolbar. The alerts may be done via Real Simple Syndication (RSS) functionality as pushed by the service provider in a private, protected online channel. Alerts may be sent to the entire community of toolbars at one time. When an alert is pushed to the toolbar and has not been seen by the user, the Alerts button and icon may change appearance to notify the user that a new alert has been sent and not yet seen. Once all sent alerts are read, the toolbar will change the icon back to the original color/display.

The toolbar may be configured to display a maximum number of alerts (e.g., three) at any given time. Then, new alerts coming in will replace the oldest alert in the toolbar. Alerts may be set to only be live for a sender-specified period of time when the alert is created (e.g., in days). After than time, the alert will expire and be removed from the toolbar view, and may be recovered by the end user.

The alerts may be simple text messages, and may be hyperlinked to any URL specified by the sender. The alert hyperlinks can be implemented to pass no affiliate coded variables or DNS information.

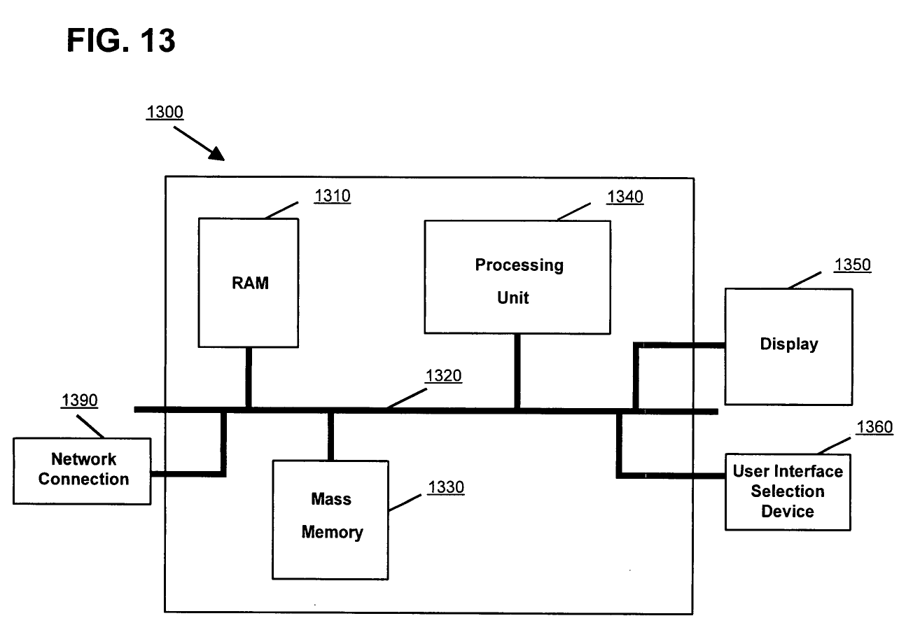

FIG. 13 is a block diagram of a computer upon which the toolbar is executed. The computer (1300) includes a processing unit (1340), active memory (1310), archival memory or storage (1330), a display (1350), the user interface selection device (1360), and a network connection (1390). The elements are connected by a bus or busses (1320).

The toolbar components (toolbar, installation windows, upgrade windows, etc.) and associated flows/pages (e.g. WHOIS Search Results, WHOIS Entry, Wildcard Search, etc.) may be created with centralized branding resource files to allow the provider of the toolbar to quickly change the branding with ease.

Communications to/from the toolbar and associated flows/pages may be created with de-coupled standard APIs. This will allow a toolbar service provider to reuse the front-end results pages.

Embedded in the toolbar may be a specific (to each end-user) and/or unique identifier code so that a WHOIS service provider, domain name registrar, or intervening service provider can know each end-user's traffic and subsequent sales derived from the toolbar. Further, each button or hyperlink within the toolbar may invoke pre-defined (e.g., by the provider of the toolbar) specific codes so that the subsequent traffic and sales generated from the toolbar will be recognized.

Additionally, the specific code allows a service provider to independently limited the number of queries from any particular toolbar per day, and may separately, limit the number of queries per hour, or other time period.

An ancillary application allows the toolbar provider to “pre-load” the identifier code to each toolbar prior to distribution of the toolbar. The toolbar provider may provide the ancillary application with the following fields—(1) each users name, (2) a unique ID (“affiliateID”), and (3) each users (delivery) email address. The ancillary application applies each affiliateID to each instance of the toolbar and generates a pre-defined “Welcome” message to the end user that contains the customized-to-the-end user toolbar executable pre-loaded with the unique affiliateID for that end user. Toolbar and service providers may be provided the ability to query for a single affiliateID or email address as stored by the ancillary application.

The ability to push version updates to all toolbars in active service may be included. This helps in the event of a critical bug that needs to be fixed in active toolbars. This can be done by a routine run in each toolbar to check for a new update upon each new browser session when the toolbar is active in the browser.

The toolbar may notify the user that a new upgraded version is available, offer the user a hyperlink to find out more information, and ask the user if he wants to install now, or ask the user to uninstall the toolbar.

Other features that may be included in the toolbar comprise the ability for user to see WHOIS history changes; the ability for user to get alerts based upon the domains they have searched; a SPAM database lookup; a DNS lookup; a Reverse DNS lookup; Tracert; Ping; Abuse lookup; ISP cached DNS lookup; and IP routing lookup.

Several embodiments of the invention are specifically illustrated and/or described herein. However, it will be appreciated that modifications and variations of the invention are covered by the above teachings and within the purview of the appended claims without departing from the spirit and intended scope of the invention.

What is claimed is:

1. A toolbar, operable on a computer system including a display having a graphical user interface, the toolbar comprising:
a first plurality of selectable items, each item corresponding to a predefined interaction with a WHOIS database;
a text entry box; and
an agent to receive a first selection of an item of the first plurality of selectable items and a string from the text entry box, and to prepare and send a first query for the WHOIS database, over a network, based upon the first selection and the string, and to output first results received in response to the first query to the display,
wherein the toolbar is a plug-in to a web browser program,
wherein the toolbar is to be selectively displayed, an option to be provided to display and hide the toolbar; and
wherein, if set to be displayed. at least a portion of the toolbar is to be persistently displayed in a graphical user interface, independent of changes in content displayed by the web browser program.

2. The toolbar according to claim 1, wherein said agent is to output the first results received in response to the first query on the display through the web browser program.

3. The toolbar according to claim 1, wherein said first plurality of selectable items is a pull-down menu or a plurality of buttons.

4. The toolbar according to claim 1, wherein an item of the first plurality of selectable items corresponds to performing a search for the WHOIS database based upon the string received in the text entry box.

5. The toolbar according to claim 4, wherein the search is a WHOIS search based upon a domain name.

6. The toolbar according to claim 4, wherein the search is a WHOIS search based upon an Internet Protocol (IP) address.

7. The toolbar according to claim 4, wherein the search is a WHOIS search based upon a Network Information Center (NIC) handle.

8. The toolbar according to claim 4, wherein the search is a wildcard search.

9. The toolbar according to claim 8, wherein the wildcard search is a WHOIS search of at least all current domains.

10. The toolbar according to claim 9, wherein the wildcard search further includes deleted domains.

11. The toolbar according to claim 8, wherein for the received string, the first results received in response to the first query include, and are to be displayed with, an independent status for each domain.

12. The toolbar according to claim 1, wherein the computer system further includes a user-interface selection device enabling a user to select content on the display, the toolbar further comprising:
a pop-up menu, to be activated by the user through the user interface selection device, the pop-up menu including a second plurality of selectable items, each item corresponding to a predefined interaction with the WHOIS database; and
wherein the agent is to further receive selected content and a second selection of an item of the second plurality of selectable items, and is to prepare and send a second query for the WHOIS database, over a network, based upon the selected content and the second selection, and to output second results received in response to the second query on the display.

13. The toolbar according to claim 12, wherein the selected content is text.

14. The toolbar according to claim 12, wherein the selected content is a graphic object including embedded information, said agent using at least some of the embedded information to prepare the second query.

15. A method of querying a WHOIS database using a toolbar which is a plug-in to a web browser program, the method comprising:
providing an option to display and hide the toolbar;
displaying the toolbar including a text entry box and a first plurality of selectable items, each item corresponding to a predefined interaction with the WHOIS database, at least a portion of the toolbar being persistently displayed, independent of changes in content displayed by the web browser program;
receiving a string from the text entry box;
receiving a first selection of an item from the first plurality of selectable items;
preparing and sending, over a network from the toolbar, a first query for a WHOIS database based upon the received string and the received item of the first selection;
receiving first results in response to the first query; and
displaying the first results.

16. The method according to 15, wherein displaying the first results comprises displaying the first results through the web browser program.

17. The method according to 15, wherein an item of the first plurality of selectable items corresponds to performing a search for the WHOIS database based upon the string received in the text entry box.

18. The method according to 17, wherein the search is a WHOIS search based upon a domain name.

19. The method according to 17, wherein the search is a WHOIS search based upon an Internet Protocol (IP) address.

20. The method according to 17, wherein the search is a WHOIS search based upon a Network Information Center (NIC) handle.

21. The method according to 17, wherein the search is a wildcard search.

22. The method according to claim 21, wherein the wildcard search is a WHOIS search of at least all current domains.

23. The method according to claim 22, wherein the wildcard search further includes deleted domains.

24. The method according to claim 21, wherein for the received string, the first results received in response to the first query include, and are displayed with, an independent status for each domain.

25. The method according to claim 15, further comprising:
receiving a second selection of content displayed on a display of a computer;
displaying, in response to a signal from a user interface selection device, a pop-up menu;
defining, on the pop-up menu, a second plurality of interactions with a WHOIS database for the content of the second selection;
receiving a third selection of an interaction from the second plurality of interactions;
preparing and sending, over the network from the toolbar, a second query for a WHOIS database based upon the received content of the second selection and the received interaction of the third selection;
receiving second results in response to the second query; and
displaying the second results.

26. The method according to 25, wherein displaying the second results comprises displaying the second results through the web browser program.

27. The method according to 25, wherein a defined interaction of the second plurality of interactions corresponds to performing a search for the WHOIS database based upon the received item of the second selection.

28. The method according to 27, wherein the search is a WHOIS search based upon a domain name.

29. The method according to 27, wherein the search is a WHOIS search based upon an Internet Protocol (IP) address.

30. The method according to 27, wherein the search is a WHOIS search based upon a Network Information Center (NIC) handle.

31. The method according to 27, wherein the search is a wildcard search.

32. The method according to claim 31, wherein the wildcard search is a WHOIS search of at least all current domains.

33. The method according to claim 32, wherein the wildcard search further includes deleted domains.

34. The method according to claim 31, wherein the second results received in response to the second query include, and are displayed with, an independent status for each domain.

35. The method according to claim 25, wherein the received content of the second selection is text.

36. The method according to claim 25, wherein the received content of the second selection is a graphic object including embedded information, and said preparing and sending the second query includes using at least some of the embedded information to prepare the second query.

37. A machine-readable medium storing instructions adapted to be executed by a processor, as a plug-in to a web browser, to perform a method comprising:
providing an option to display a toolbar as a component of the web browser and to hide the toolbar;
displaying the toolbar including a text entry box and a first plurality of selectable items, each item corresponding to a predefined interaction with a WHOIS database, at least a portion of the toolbar being persistently displayed, independent of changes in content displayed by the web browser;
receiving a string from the text entry box;
receiving a first selection of an item from the first plurality of selectable items;
preparing and sending, over a network from the toolbar, a first query for a WHOIS database based upon the received string and the received item of the first selection;
receiving first results in response to the first query; and
displaying the first results.

38. The machine-readable medium according to 37, wherein displaying the first results comprises displaying the first results through the web browser.

39. The machine-readable medium according to 37, wherein an item of the first plurality of selectable items corresponds to performing a search for the WHOIS database based upon the string received in the text entry box.

40. The machine-readable medium according to 39, wherein the search is a WHOIS search based upon a domain name.

41. The machine-readable medium according to 39, wherein the search is a WHOIS search based upon an Internet Protocol (IP) address.

42. The machine-readable medium according to 39, wherein the search is a WHOIS search based upon a Network Information Center (NIC) handle.

43. The machine-readable medium according to 39, wherein the search is a wildcard search.

44. The machine-readable medium according to claim 43, wherein the wildcard search is a WHOIS search of at least all current domains.

45. The machine-readable medium according to claim 44, wherein the wildcard search further includes deleted domains.

46. The machine-readable medium according to claim 43, wherein for the received string, the first results received in response to the first query include, and are displayed with, an independent status for each domain.

47. The machine-readable medium according to claim 37, the method further comprising:
receiving a second selection of content displayed on a display of a computer;
displaying, in response to a signal from a user interface selection device, a pop-up menu;
defining, on the pop-up menu, a second plurality of interactions with a WHOIS database for the content of the second selection;
receiving a third selection of an interaction from the second plurality of interactions;
preparing and sending, over the network from the toolbar, a second query for a WHOIS database based upon the received content of the second selection and the received interaction of the third selection;
receiving second results in response to the second query; and
displaying the second results.

48. The machine-readable medium according to 47, wherein displaying the second results comprises displaying the second results through the web browser.

49. The machine-readable medium according to 47, wherein a defined interaction of the second plurality of interactions corresponds to performing a search for the WHOIS database based upon the received item of the second selection.

50. The machine-readable medium according to 47, wherein the search is a WHOIS search based upon a domain name.

51. The machine-readable medium according to 47, wherein the search is a WHOIS search based upon an Internet Protocol (IP) address.

52. The machine-readable medium according to 47, wherein the search is a WHOIS search based upon a Network Information Center (NIC) handle.

53. The machine-readable medium according to 47, wherein the search is a wildcard search.

54. The machine-readable medium according to claim 53, wherein the wildcard search is a WHOIS search of at least all current domains.

55. The machine-readable medium according to claim 54, wherein the wildcard search further includes deleted domains.

56. The machine-readable medium according to claim 53, wherein the second results received in response to the second query include, and are displayed with, an independent status for each domain.

57. The machine-readable medium according to claim 47, wherein the received content of the second selection is text.

58. The machine-readable medium according to claim 47, wherein the received content of the second selection is a graphic object including embedded information, and said preparing and sending the second query includes using at least some of the embedded information to prepare the second query.

59. A toolbar comprising:
a plurality of selectable items, each item corresponding to a predefined interaction with a domain name registrar;
a text entry box; and
an agent to receive a selection of an item of the plurality of selectable items and a string from the text entry box, and to prepare and send a request for the domain name registrar, over a network, based upon a selected item and the string, and to output results received in response to the request to a display,
wherein the toolbar is a plug-in to a web browser program;
wherein the toolbar is to be selectively displayed, an option to be provided to display and hide the toolbar; and
wherein, if set to be displayed, at least a portion of the toolbar is to be persistently displayed in a graphical user interface, independent of changes in content displayed by the web browser program.

60. The toolbar according to claim 59, wherein said agent is to output the results received in response to the query on the display through the web browser program.

61. The toolbar according to claim 59, wherein said plurality of selectable items is a pull-down menu or a plurality of buttons.

62. The toolbar according to 59, wherein an item of the plurality of selectable items corresponds to registering a new domain name with the registrar based upon the string received in the text entry box.

63. The toolbar according to 59, wherein an item of the plurality of selectable items corresponds to transferring an existing domain name registration to the registrar based upon the string received in the text entry box.

64. The toolbar according to 59, wherein an item of the plurality of selectable items corresponds to renewing an existing domain name registration with the registrar based upon the string received in the text entry box.

65. A method of interacting with a domain name registrar using a toolbar which is a plug-in to a web browser program, the method comprising:
providing an option to display and hide the toolbar;
displaying the toolbar including a text entry box and a plurality of selectable items, each item corresponding to a predefined interaction with the domain name registrar, at least a portion of the toolbar being persistently displayed, independent of changes in content displayed by the web browser program;
receiving a string from the text entry box;
receiving a selection of an item from the plurality of selectable items;
preparing and sending, over a network, a request for the domain name registrar based upon the string and the selected item;
receiving results in response to the query; and
displaying the results.

66. The method according to 65, wherein displaying the results comprises displaying the results through the web browser program.

67. The method according to 65, wherein an item of the plurality of selectable items corresponds to registering a new domain name with the registrar based upon the string received in the text entry box.

68. The method according to 65, wherein an item of the plurality of selectable items corresponds to transferring an existing domain name registration to the registrar based upon the string received in the text entry box.

69. The method according to 65, wherein an item of the plurality of selectable items corresponds to renewing an existing domain name registration with the registrar based upon the string received in the text entry box.

70. A machine-readable medium storing instructions adapted to be executed by a processor, as a plug-in to a web browser, to perform a method comprising:
providing an option to display a toolbar as a component of the web browser and to hide the toolbar;
displaying the toolbar including a text entry box and a plurality of selectable items, each item corresponding to a predefined interaction with a domain name registrar, at least a portion of the toolbar being persistently displayed, independent of changes in content displayed by the web browser;
receiving a string from the text entry box;
receiving a selection of an item from the plurality of selectable items;
preparing and sending, over a network, a request for the domain name registrar based upon the string and the selected item;
receiving results in response to the query; and
displaying the results.

71. The machine-readable medium according to 70, wherein displaying the results comprises displaying the results through the web browser.

72. The machine-readable medium according to 70, wherein an item of the plurality of selectable items corresponds to registering a new domain name with the registrar based upon the string received in the text entry box.

73. The machine-readable medium according to 70, wherein an item of the plurality of selectable items corresponds to transferring an existing domain name registration to the registrar based upon the string received in the text entry box.

74. The machine-readable medium according to 70, wherein an item of the plurality of selectable items corresponds to renewing an existing domain name registration with the registrar based upon the string received in the text entry box.
